(19) United States
(12) Patent Application Publication
(10) Pub. No.: US 2023/0185624 A1
(43) Pub. Date: Jun. 15, 2023

(54) ADAPTIVE FRAMEWORK TO MANAGE WORKLOAD EXECUTION BY COMPUTING DEVICE INCLUDING ONE OR MORE ACCELERATORS

(71) Applicant: Intel Corporation, Santa Clara, CA (US)

(72) Inventors: Le Yao, Shanghai (CN); Ruijing Guo, Shanghai (CN); Malini K. Bhandaru, San Jose, CA (US); Qiaowei Ren, Shanghai (CN); Haibin Huang, Hangzhou (CN); Ruoyu Ying, Shanghai (CN)

(73) Assignee: Intel Corporation, Santa Clara, CA (US)

(21) Appl. No.: 17/952,120

(22) Filed: Sep. 23, 2022

(30) Foreign Application Priority Data
Aug. 6, 2022 (WO) PCT/CN2022/110729

(51) Int. Cl. G06F 9/50; G06F 9/54

(52) U.S. Cl. CPC G06F 9/505; G06F 9/54

(57) ABSTRACT

A processing circuitry, a method to be performed at the processing circuitry, a computer-readable storage medium, and a computing system. The processing circuitry is to determine a first mapping between a first set of data parameters and first computing units of a computing network; select, based on the first mapping and on first data having a first workload associated therewith, one or more of the first computing units to execute the first workload, and send for execution the first workload to the one or more of the first computing units; determine a second mapping based on a change in computing units from the first computing units to second computing units, the second mapping between a second set of data parameters and the second computing units; and select, based on the second mapping and on second data having a second workload associated therewith, one or more of the second computing units to execute the second workload.

### CROSS REFERENCE TO RELATED APPLICATIONS

This patent application claims the benefit of the filing date of International Application No. PCT/CN2022/110729, filed on Aug. 6, 2022, and entitled “ADAPTIVE FRAMEWORK TO MANAGE WORKLOAD EXECUTION BY COMPUTING DEVICE INCLUDING ONE OR MORE ACCELERATORS,” the contents of which are hereby expressly incorporated by reference.

### BACKGROUND

A computing network, such as a data center, may include computing devices including one or more computing units. A computing unit includes one or more central processing units (CPUs) and one or more accelerators or accelerator processing circuitries (APUs). APUs correspond to hardware acceleration units to which workloads may be offloaded. Multiple types of APUs are available, including for various functions, such as encryption, decryption, compression, decompression, graphics processing, streaming data movement and streaming data transformation, data input/output (I/O), or artificial intelligence (AI) functions/machine learning (ML) functions, to name a few.

When there is a change to computing units of a computing device, exiting libraries threaded into workload requests by clients must be modified. For example, such modification may include logic to check for the existence of additional accelerators, so that the libraries can route workloads to either the CPUs or the APUs. The library modifications are manually hard coded based on the changes to the computing units.

### BRIEF DESCRIPTION OF THE DRAWINGS

FIG. 1 depicts a data flow through a computing device according to an example embodiment.

FIG. 2 depicts a computing environment according to an example embodiment.

FIG. 3 depicts an example architecture for the computing device of FIG. 2.

FIG. 4 depicts an example computing system including a computing device according to an embodiment.

FIG. 5 depicts an example computing core system.

FIG. 6 depicts a process according to some embodiments.

### DETAILED DESCRIPTION

Some embodiments provide an apparatus of a computing network, the computing network including a plurality of computing units. The computing units are subject to change, and include a central processing circuitry (CPU) and one or more accelerator processing circuitries (APUs). The apparatus and the computing units may all be part of a same computing device of a computing network, such as a computing node of a data center. The apparatus includes a processing circuitry to determine a first mapping between a first set of data parameters and first computing units of the computing network. The first mapping may be in memory, and may be accessed by the processing circuitry from the memory. The first computing units correspond to a first set of computing units of the computing network before a given change in computing units is implemented. The processing circuitry is to select, based on the first mapping and on first data having a first workload associated therewith, one or more of the first computing units to execute the first workload. The processing circuitry may receive the first data from a library of the computing network, for example as a first API call for execution of the first workload. The processing circuitry may send for execution the first workload to the one or more of the first computing units that it has a selected.

However, when a change to the computing units of the computing network take place, for example when new CPU functionality is added or otherwise changed, or when new APUs are added or otherwise changed, a second mapping is needed for the processing circuitry to allow it to determine how to route workloads to the changed computing units. The processing circuitry according to embodiments is to determine a second mapping based on a change in computing units of the computing network from the first computing units to second computing units, the second mapping being between a second set of data parameters and the second computing units. The processing circuitry is then to select, based on the second mapping and on second data having a second workload associated therewith, one or more of the second computing units to execute the second workload, and send for execution the second workload to the one or more of the second computing units.

A data parameter according to some embodiments may include any information that would allow the processing circuitry to make a decision regarding which computing unit to send the data to. A data parameter may for example include object information on the object that represents the data being received by a processing circuitry, including the workload to be executed and the data that relates to execution of the workload. For example, a data parameter may include data size for a data packet (e.g., object) that is received by the processing circuitry. A data parameter according to some embodiments may include a data source location, expected workload power usage (e.g., power usage expected to be needed to execute the workload), or whether data batch processing is possible at corresponding ones of said one or more of the first computing units or said one or more of the second computing units. The data batch processing may for example be possible where the data packet sent to the processing circuitry for triage amongst the various computing units is part of a plurality of data packets including a plurality of workload calls that could be executed by a single computing unit as a group. A data parameter may include an indication of workload type, such as information on a workload action including at least one of: encryption, decryption, compression, decompression, machine learning, streaming data movement, streaming data transformation, or data input/output (I/O), to name a few.

Advantageously, some embodiments provide a framework implemented in software that provides auto-detection of computing unit changes in a computing device of a computing network, followed by smart selection of computing units to execute a workload associated with data accessed by the framework. In this manner, changes to computing units of a computing device, such as changes in APUs or changes in CPUs, would not need to be manually hard coded by a user of the computing device, nor would hard coding need to be made to a library coupled to the computing units to correlate API calls to the new profile of computing units, as such correlation is made automatically by a framework according to some embodiments. More particularly, some embodiments obviate the need for user to call a specific computing unit API, or to set up any threshold on data parameters for data associated with a workload to enable use of a particular computing unit.

Some embodiments advantageously expose uniform APIs for workload execution according to workload type (i.e., one or more functionalities associated with a workload, such as encryption, decryption, compression, decompression, graphics processing, streaming data movement and streaming data transformation, data input/output (I/O), artificial intelligence (AI) functions/machine learning (ML) functions, to name a few). According to some embodiments, users can simply call an API in their own software stack. The API call may then be routed to the software framework according to some embodiments, where the methodology itself decides whether to offload the corresponding workload to an APU or use a CPU directly based on a mapping between data parameters associated with the workload on one hand, and a computing unit to be selected for execution of the workload.

Some embodiments provide a framework that uses a mapping between data parameters and computing units of a computing device with a goal of allowing a processing circuitry executing the framework to select a computing unit for execution of a workload that provides an improved performance (i.e., relative to available computing units that the framework is aware of). An “improved performance” may be determined by the framework during determination of the mapping, for example based on performance metrics provided to it by the computing units.

The framework may develop the mapping between data parameters and computing units of a computing device for example by developing a list of workloads (or tasks) that may be efficiently executed at one or more APUs of the computing device, or that may be efficiently executed at the CPU. In such a case, the determination of what is or is not efficient may take into account, at the framework, a knowledge regarding a time duration to transfer the data associated with the workload to a computing unit, along with a size of the data. In the event that more than one APU is available the execute the workload, the framework may compare their respective performance metrics to determine a most efficient selection of a computing unit to execute the workload. Over time, the framework may be self-adapting, in that it may learn mappings from input tasks (input data to the processing circuitry to execute the framework, the input data associated with the workload) to the various computing units, such as the CPU, graphics processing circuitry (GPU), field programmable gate array (FPGA) or other APUs.

Advantageously, embodiments facilitate the deployment of APUs into computing networks such as data centers, and make it much more efficient to in this manner improve the streamlining of workflows for users. Although sophisticated users who may be well aware of the availability of APU and host capabilities within their networks might be able to relatively readily hard code their accelerator use into a computing device library, general end-users may greatly benefit from embodiments without having to become experts in the space of scaling the compute capabilities of a computing device to be deployed in a computing network. Even for sophisticated users, the framework's ability to auto-detect changes in computing units in a computing device, and to correlate data parameters with computing units to execute workloads in an adaptive manner through one or more learning cycles, provides the advantage that, as computing networks scale, changes in computing units within computing nodes of the network can be efficiently and automatically integrated into the workflow processing pipelines of the network without the need for the hardcoding of computing device libraries, and without the need to alter API calls initiated by such libraries based on received data.

In the current state of the art, network packets received by a computing device, such as a computing node of a data center, are typically routed to a library of the computing device. Computing device libraries may include, for example, known libraries such as OpenSSL, Boring SSL, Zlib, or other similar libraries. OpenSSL refers to an open source library for general-purpose cryptography and secure communication, managed by the OpenSSL Software Foundation (OSF). Boring SSL is a fork of OpenSSL that is designed to meet Google's needs. Zlib is a software library used for data compression. TensorFlow is an end-to-end open source platform for machine learning (ML), and has an ecosystem of libraries that facilitates the deployment ML powered applications.

The library generates an API call based on the received data, and routes it to either the CPU or to one or more APUs of the computing device for execution of the associated workload based on a mapping hard coded therein.

If computing units of the computing device change, for example, if an APU is added, or if functionality of either the CPU or an APU is changed, a user is to, based on the current state of the art, manually hard code the existing libraries that are threaded into application programs. For example, in OpenSSL code there may be logic to check for the existence of an attached encryption APU and to use the same. Such APUs, however, may not be useful where use of the same may introduce enough overhead into the flow to more than counterbalance any efficiency benefits expected from use of the APUs. The overhead may be brought about, for example, by the transmission of data from the CPU or via direct memory access to the APU when the data below a given threshold for the workload to be performed, for example, if the workload include encryption and the encryption keys are less than 1024 bits. For example, it may not be worth (e.g., it may not make performance of the computing unit more efficient) encrypting a single key using an APU, but it may be worth encrypting a whole page or an image.

Some embodiments provide a processing circuitry of a computing device that is to, during a learning phase or initialization phase, query computing units of a computing device in order to determine performance metrics of the same, and to generate mapping entries between data parameters to be received at the processing circuitry and individual computing units of the computing device to execute a workload associated with the data. According to some embodiments, APUs added to a computing device may, for example during initialization, register with the software framework by sharing an API with the software framework, which API may contain information to allow the framework to query the added computing units regarding their information, such as APU type, APU generation, performance data including performance capabilities and performance metrics.

An APUs performance may differ with its generation. In addition, changes to the computing units may include new algorithms, new tuning, instruction set enhancements, changes to the cache such as cache additions, changes to form factor, and/or faster buses. Some embodiments include a software framework that accesses information regarding such computing units in order to be able to route traffic to an optimal or near optimal computing unit of the computing device based on this knowledge.

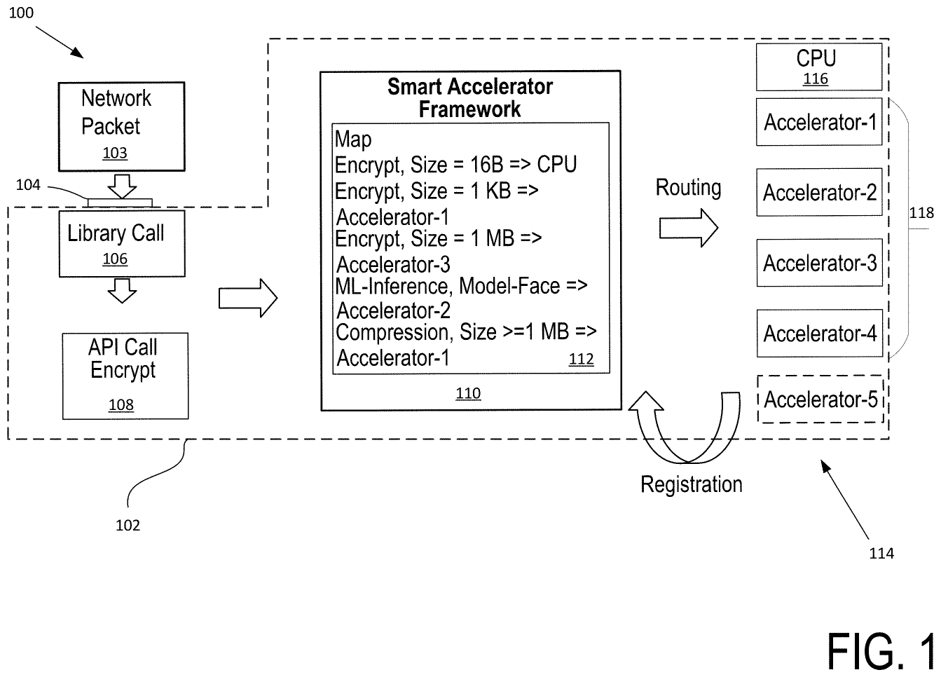

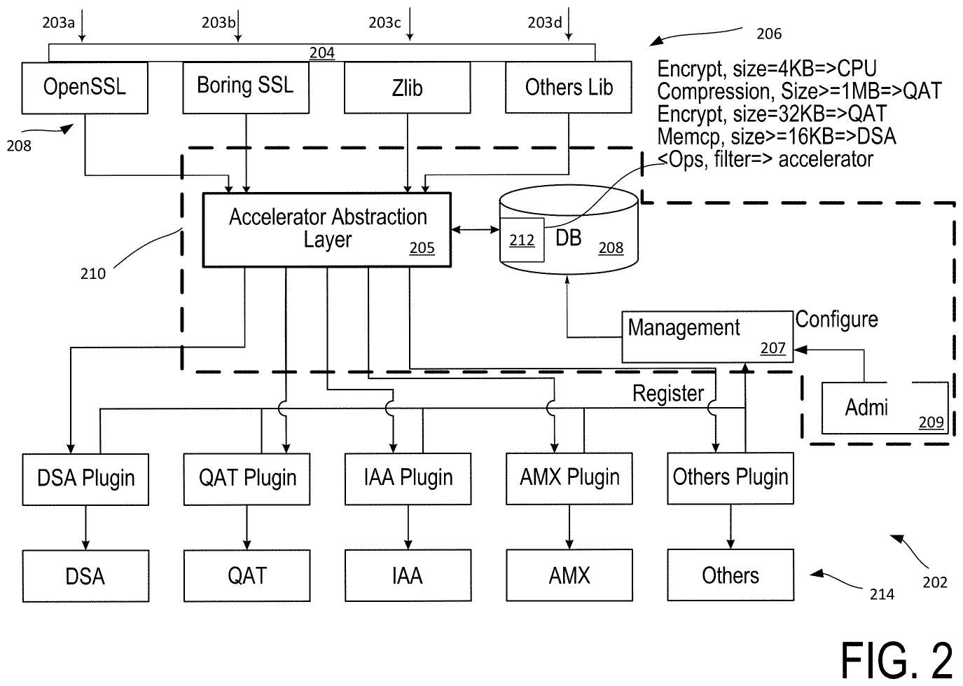

The software framework according to some embodiments, upon detecting a new APU for example, may query the API generated by the APU for performance data or performance metrics of interest, which ideally would be well-known/standard across different vendor solutions providing similar functionality. Based on such performance information, the software framework may adjust its code paths regarding which computing unit of the computing device is to execute which workload. The software framework may adjust its code paths after it implements its own self-test on performance, for example by performing the initialization function mentioned previously, as will be described in further detail below in the context of FIGS. 1 and 2 below.

For the purposes of this disclosure, a “computing unit” includes any physical component or virtual machine capable of processing some or all of a network packet, including the execution of a workload based on associated data. Example computing units include, but are not limited to a virtual machine or a physical component that corresponds to an XPU, a CPU, a FPGA, a GPU, an APU (or other co-processor), a core, a CPU complex, a server complex, an ASIC, an uncore, to name a few. A computing unit as used herein may be embodied as part of a system-on-a-chip (SoC) that includes one or more processors, included on a multichip package that also contains one or more processors, or embodied as a discrete chip, as an uncore of a component, by way of example.

As used herein, “library” refers to one or more software modules, functions and/or prewritten codes that are to perform a set of well-defined and specific operations, including for example the generation of API calls based on a workload associated with data received at the library. A library may be stored in a memory of a computing unit that is to use the library, or it may be stored in a memory external to the computing unit, or both.

As used herein a “computing network” may include any number of networked computing nodes (or computing devices) with each computing node including any number of computing units (e.g., CPUs) and any number of associated memory circuitries (e.g., caches) in any configuration. A “computing network” as used herein may, by way of example, include a data center, a nano data center, a rack of networked computing devices, a cellular network, or an edge cloud network. According to some embodiments, a “computing network” may include a plurality of disaggregated server architectures. For example, in an edge cloud network, computing may be performed at or closer to the “edge” of a network, which may use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

A “memory” as used herein, used in the context of a server architecture includes a memory structure which may include at least one of a cache (such as a L1, L2, L3 or other level cache including last level cache), an instruction cache, a data cache, a first in first out (FIFO) memory structure, a last in first out (LIFO) memory structure, a time sensitive/time aware memory structure, a ternary content-addressable memory (TCAM) memory structure, a register file such as a nanoPU device, a tiered memory structure, a two-level memory structure, a memory pool, or a far memory structure, to name a few. According to embodiments, a “memory circuitry” as used herein may include any of the above non-cache memory structures carved out of a cache (e.g., carved out of a L1 cache) or separate from said cache. As used herein, “a memory of a server architecture” may include one or more memory circuitries.

A “processing circuitry” as used herein may include one or more processors. A processor of a processing circuitry may include any circuitry that is to execute a workload or task. A “processing circuitry” of a computing device that implements a smart accelerator framework according to embodiments may reside in a CPU of the computing device, and/or it may reside in a dedicated processing circuitry of the computing device other than the CPU.

In the following figures, like components will be referred to with like and/or the same reference numerals. Therefore, detailed description of such components may not be repeated from figure to figure.

Reference is now made to FIGS. 1 and 2, which show, respectively, a computing environment and a computing device according to some embodiments.

Referring first to FIG. 1, computing environment 100 including a computing device 102 is shown in schematic form, depicting the flow of data and instructions to and through a computing device 102 according to an example embodiment. Not all components of a computing device 102 are shown in FIG. 1, but rather an environment within computing device 102 that depicts the flow of information therein.

As shown in FIG. 1, a network packet 103 including data is received at an interface 104 of the computing device 102. The network packet 103 may be generated at a client 105, such as at another computing node of the computing network that includes computing device 102. The input/output interface 104 may use at least one of Peripheral Component Interconnect (PCI), PCI express (PCIe), PCIx, Universal Chiplet Interconnect Express (UCIe), Intel On-chip System Fabric (IOSF), Gen-Z, Open Coherent Accelerator Processor Interface (OpenCAPI), and/or Compute Express Link (CXL), Serial ATA, and/or USB compatible interface (although other interconnection standards may be used). Interface 104 is to couple the computing device 102 to a computing network such as a data center to receive signals therefrom, such as network packets that include data, such as data associated with a workload or instructions.

Computing environment 100 includes a library 106 that may determine a library call from the data 103. The library may include, for example, one or more known libraries such as OpenSSL, Boring SSL, Zlib, TensorFlow, or other similar libraries. The library 106 generates an API call 108 based on the received data in the network packet 103, and routes it to a Smart Accelerator Framework (SAF) 110 according to one example embodiment. SAF 110 is a software framework that may be implemented in a processing circuitry of the computing device 102, such as its CPU. SAF 110 may determine a mapping 112 that maps data parameters. SAF 110 may determine the mapping 112 by, for example, accessing the mapping to see a computing unit match for a data parameter for the network packet 103. In the shown example, the workload associated with the data in network packet 103 is encryption, as suggested by API call “Encrypt” 108. SAF 110 uses the mapping 112 to match parameters of the data of network packet 103 with one of the available computing units of the computing device 102. A match would result in SAF 110 selecting a computing unit of a plurality of computing units 114 of the computing device 102 to execute the workload that is associated with the network packet 103. The mapping 112 includes a set of data parameters for data that is the subject of an API call 108 from the library 106. The set of data parameters in mapping 112 include sizes of the data (e.g., whether 16B, 1 KB, 1 MB, ≥1 MB), the workload type (e.g., encryption, ML function, compression). For example, according to mapping 112, if the workload type is encryption, and: (1) the data size 16 MB, the workload is to be executed at the CPU, (2) the data size is 1 KB, the workload is to be executed at Accelerator 1 of the set of APUs 118; (3) the data size is 1 MB, the workload is to be executed at Accelerator 3. However, if the workload type concerns the inference stage of a ML process, the workload is to be executed at Accelerator 2. Finally, if the workload type concerns compression, and the data size is more than or equal to 1 MB, then the workload is to be executed at Accelerator 1.

The mapping 112 may be determined by SAF 110 either by the SAF accessing the mapping at a local memory (i.e., memory of the computing device 102—not shown FIG. 1), or by the SAF accessing the mapping at a memory that is external to the computing device 102, and for example still within the computing network to which computing device 102 is to belong.

Once SAF 110 selects the mapped computing unit for the data parameter that is relevant to network packet 103 and API call 108, SAF 110 may send or route the workload for execution at the mapped computing unit.

The processing circuitry at which SAF 110 is to be implemented may correspond to CPU 116, or to another circuitry of the computing device 102, such as a dedicated SAF processing circuitry. Where SAF 110 is implemented at CPU 116, the sending or routing of the workload for execution is to denote that the same computing unit that selects the mapped computing unit for execution of the workload in question is the one that is also to access the workload and to execute that workload based on the mapping.

According to some embodiments, SAF 110 may adaptively automatically change the mapping as changes happen to the computing units 114 of computing device 102. For example, if a new APU is added to the computing resources of the computing device 102, such as Accelerator 5 shown in broken lines in FIG. 1, instead of a user having to manually hard code library 106 to set conditions for mapping incoming workloads to computing units, as is being done in the state of the art, SAF 110 is to change the mapping to a new mapping (a second mapping) that takes data parameters and the change in the computing units into account, for example by implementing an initialization/registration process as will be described in further detail below.

Once Accelerator 5 is added to the computing device 102, SAF 110 may detect the same for example by accessing identifying information regarding Accelerator 5, such as, for example, by accessing information on whether the new computing unit (Accelerator 5) is a CPU, APU, or other type of processor (i.e., information on computing unit type); the generation and/or version of Accelerator 5; the function(s) that are to be performed by Accelerator 5; etc. For example, Accelerator 5 may generate an API call that allows SAF 110 to access the identifying information described above.

Based on the identifying information, the SAF 110, as implemented by a processing circuitry, may determine a second mapping that is different from the first mapping 112 shown in FIG. 1. For example, based on the identifying information, SAF 110 may implement, in one embodiment, an initialization function that includes one or more learning cycles, as will be explained in further detail below. The initialization function may be implemented to take place for a predetermined time duration, and/or based on a number of factors, such as whether all workload types of a set of predetermined workload types were used during the initialization function, whether all data sizes of a set of predetermined data sizes were used during the initialization function, or whether all identified/available computing units of the computing device were used during the initialization function, to name a few examples. After the initialization function is completed, the generated second mapping may be stored in memory, such as a memory of the computing device, or a memory of the computing network external to the computing device.

According to an embodiment, the initialization function may be performed by SAF 110 in-line, that is, while the computing device 102 is executing workloads, for example still using the first mapping 112 until the second mapping is established.

An individual learning cycle of the initialization function according to some embodiments may include SAF 110 sending one or more workloads (e.g., workloads associated with data that is received by the computing device 102 of FIG. 1, and that leads to the generation of an associated API call from library 106) to at least some of the new set of computing units (that is, CPU 116, and Accelerators 1-5, with Accelerator 5 having been added) for execution. SAF 110 may collect performance data based on execution of the workload at said some of the new set of computing units, and generate entries for the second mapping based on the performance data. The performance data may include performance metrics, such as how fast individual ones of the computing units execute the workload (speed of execution), how much power individual ones of the computing units use to execute the workload (power consumption), or how many errors and/or what types of errors if any are generated by individual ones of the computing units if any from execution of the workload (number or type of errors).

Reference is now made to FIG. 2, which shows a computing environment 200 inside computing device 202 of FIG. 1 by way of example. Computing environment 200, similar to computing environment 100 of FIG. 1, and computing device 202 may be similar to computing device 102 of FIG. 1. Computing environment 200 depicts the flow of data and instructions to and through a computing device 202 according to an example embodiment. Not all components of a computing device 202 are shown in FIG. 2, but rather an environment within computing device 202 that depicts the flow of information therein.

As shown in FIG. 2, possible network packets 203 (203a, 203b, 203c and 203d) including data are received at an interface 204 of the computing device 202. The network packets 203 may be generated at one or more clients, such as at another computing node of the computing network that includes computing device 202. Interface 204 is to couple the computing device 202 to a computing network such as a data center to receive signals therefrom, such as network packets that include data, such as data associated with a workload or instructions. Interface 204 may be similar to interface 104 of FIG. 1.

Computing environment 200 includes libraries 206 each comparable to library 106 of FIG. 1 by way of example. Libraries 206 may determine respective library API calls from the data in respective network packets 203a-203d. The shown libraries include OpenSSL, Boring SSL, Zlib, and other similar libraries. The libraries 206 may generate respective API calls 208 based on the received data in the network packets 203, and route them to an Accelerator Abstraction Layer (AAL) 205 of a Smart Accelerator Framework (SAF) according to one example embodiment. The SAF in FIG. 2 includes the AAL 205, a database (DB) 208 to store the mapping 212, a management engine 204 and an administration engine 209, as will be explained in further detail below. The SAF of FIG. 2 may be similar to SAF 110 of FIG. 1 in its functioning.

The shown computing units 214 of the computing device 202 of FIG. 2 include, by way of example only, a data streaming accelerator (DSA), a QuickAssist technology (QAT) accelerator for security, authentication, and compression, an Intel Application Accelerator (IAA), an Advanced Matrix Extensions (AMX) accelerator to accelerate artificial intelligence (AI) and/or ML related workloads, or other processors or co-processors. Mapping 212 may be similar in its functionality to the mapping 112 described in the context of FIG. 1 above.

Clients' workload requests coming in through network packets 203 may call corresponding ones of the libraries 206, and libraries 206 (OpenSSL, Zlib, etc.) may call the AAL 205 to accelerate specified workloads. AAL 205 may access mapping 212 within DB 208 in order to select those computing units to execute respective ones of the workloads, and, where the selected computing units include APUs, may forward the object calls to suitable accelerator plugins (e.g., as shown, a DSA plugin, a QAT plugin, an IAA plugin, an AMX plugin, or other plugins). The AAL 205 therefore represents the engine that implements a selection of computing units of computing device 202 to execute a workload based on mapping 212.

Management engine 207 is the component that may collect system resource statuses from the various computing units, and generate a configuration for each CPU, and for each APU from the accelerator plugins registered to the management engine 207. A configuration of a computing unit may include, for example, information on the computing unit type. The information on the computing unit type may include information on computing unit type, the information on computing unit type including at least one of information on whether said individual ones of the second computing units include a CPU or an APU, or information on APU type. The information on the computing unit type may further include information, for an individual computing unit, on any one of: computing unit speed, computing unit generation, socket type, host bus speed, cache sizes, cache types, register sizes, data bus speeds, number of cores, number of bits supported, number of transistors, or maximum memory size available, whether the computing unit is to operate in a confidential computing environment, to name a few. A configuration of a computing unit, after detection of computing units by the management engine 207, may be stored in the DB 208 also, and accessed by the AAL 205 during selection of one or more computing units to execute workloads identified by API calls 208.

When there is a change to any of the computing units, the management engine 207 may redetect the new set of computing units, and after determination of the new configurations of the same, store their updated configurations into the DB 208 as a new, or second, set of configurations upon which AAL 205 may make a selection decision for computing units to execute workloads.

AAL 205 may determine the mapping 212 by, for example, accessing the mapping within DB 208 to see a computing unit match for a data parameter for individual ones of the network packets 203. AAL 205 may use the mapping 212 to match parameters of the data of network packet 203 with one or more of the available computing units 214 of the computing device 202, based on stored configurations of the computing units. A match would result in AAL 205 selecting one or more computing units of the plurality of computing units 214 of the computing device 202 to execute the workloads associated with respective ones of the network packets 203. The mapping 212 includes a set of data parameters for data that is the subject of an API calls 208 from the libraries 206. The set of data parameters in mapping 212 include sizes of the data (e.g., whether 4 KB, ≥1 MB, 32 KB, ≥16 KB), the workload type (e.g., encryption, compression, copying from memory (Memcp)). For example, according to mapping 212 of FIG. 2, if the workload type is encryption, and: (1) the data size 4 KB, the workload is to be executed at the CPU, and (2) the data size is 32 KB, the workload is to be executed at the QAT accelerator. However, if the workload type is compression, and the data size is more than or equal to 1 MB, the workload is to be executed at the DSA. However, if the workload type concerns copying from a memory, and the data size is more than or equal to 16 KB, the workload is to be executed at the DSA.

According to some embodiments, AAL 205 may automatically adaptively change the mapping as changes happen to the computing units 214 of computing device 202, similar to what was explained in the context of SAF 110 of FIG. 1.

Although embodiments as described above specifically call out the processing circuitry 210 that implements a SAF as being within a same computing device as the computing units to which a workload is sent for execution, embodiments are not so limited, and include within their scope a processing circuitry implementing a SAF which is located anywhere in a computing network, such as a data center or cloud network, that provide auto-detection of a change in computing units, and auto-correlation of data parameters with computing units for execution of workloads.

Referring still to FIG. 2, processing circuitry 210 may determine a first mapping between a first set of data parameters and first computing units of the computing network. A first mapping refers to an existing mapping prior to a given change in computing units. Upon a change in the computing units 214, the processing circuitry 210 may determine a second mapping between a second set of data parameters and second computing units of the computing network. In the second mapping, the second set of data parameters may be the same or different from that of the first set of data parameters, and the second computing units in the second mapping may likewise be the same or different from the first computing units in the first mapping.

A change in computing units, which may include any change in the computing resources of the computing device, including the addition, subtraction of computing units, or other change in any one of the existing computing units, including any change in their parameters (such as, for any computing unit, at least one of computing unit type, computing unit speed, computing unit generation, socket type, host bus speed, cache sizes, cache types, register sizes, data bus speeds, number of cores, number of bits supported, number of transistors, or maximum memory size available, or whether the computing unit is to operate in a confidential computing environment, to name a few) may be detected by management engine 207, and result in an updated registration of the computing units of the computing device 202, which registration would result in updated computing unit configurations being stored, for example in DB 208.

If the AAL 205 determines from stored computing unit configurations that a computing unit offers a confidential computing environment, and that a data parameter of received data indicates a workload that is to be executed in a confidential computing environment, the AAL 205 may route the workload to that computing unit. For example, where none of the APUs of FIG. 2 offer a confidential computing environment, the AAL 205 may route a workload to be executed in a confidential computing environment to the CPU for execution.

Advantageously, because the processing circuitry 210 auto detects changes in computing units through a registration or initialization process, and auto correlates (i.e., without the user needing to input hard coding of an updated mapping into libraries 206), API calls for workloads by libraries 206 may not change with a change in computing units of the computing device where the processing circuitry 210 is distinct from the libraries. Thus, according to some embodiments, a processing circuitry is to access the first data (prior to given computing unit changes) and the second data (after computing unit changes) by accessing, respectively, a first application programming interface (API) call and a second API call from a library of the computing device, the first API call and the second API call may be identical if the first workload and the second workload associated with them are identical.

According to some embodiments, the mapping 214 may be either in a DB 208 within a same computing device as the AAL 205, or it may be external to the computing device. If the memory is external to the computing device, the mapping may correspond to a cluster map that allows access to its entries to multiple computing devices/nodes of a computing network, which computing devices may then include SAFs that implement a selection of computing units based on data parameters of incoming data based on the mapping and based on the incoming data. Periodically, each computing device may synchronize its mapping entries developed as a result of the autodetection and autocorrelation process above to the cluster map.

According to an embodiment, processing circuitry 210 is to implement the initialization function inline while sending for execution the first workload to the one or more of the first computing units. The processing circuitry may further execute multiple autocorrelations of incoming workloads to computing units where the autocorrelations overlap in time.

The AAL 205 may use performance data, such as performance metrics, to select computing units to execute the workload. The performance metrics may include at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units. AAL 205 may select a computing unit per workload based for example on which computing unit may execute the workload fastest, based in part on the current load on the computing units. For example, the AAL 205 may send a request to computing units to obtain their performance data.

Advantageously, according to some embodiments, any accelerator can implement its own plugin according to the framework specification, and the accelerators 114 can register their information into the Management engine 207 through its own device plugin. Accelerator information can include accelerator capabilities, interfaces, performance metrics, and so on. After the information is registered to the Management engine 207, the Management engine 207 may generate a map based on the information of the device plugin and the configuration of the Administration engine 209, and store the map into the DB 208. This mapping stores a mapping of specific acceleration tasks and judgment criteria with other related information. Through the mapping, the framework can analyze the acceleration requests from different libraries and select the appropriate accelerators for the task acceleration. The mapping information in this table is also adaptive to change, for each acceleration task, there will be certain feedback on the acceleration performance, through this feedback, the management will adjust the mapping information so that subsequent acceleration tasks to achieve a more appropriate performance.

For a specific workload, when a library is called by a user or an application, to take full advantage of the hardware capabilities, the library will call the hardware abstraction layer through our framework according to some embodiments, and pass information about the object that needs to be accelerated, and the abstraction layer will query the device mapping table to determine which accelerator to use for the current workload. After the abstraction layer gets the specific device information, it forwards the corresponding request to the accelerator plugin registered by the accelerator and calls the corresponding API, which eventually calls the specific accelerator for hardware acceleration offloading.

Although some embodiments as described herein mention mainly the routing of a workload for execution to a computing unit, embodiments are not so limited, and include within their scope the routing of a workload to computing resources in a way that splits the execution of the workload among more than one computing units. SAF 110 may for example determine whether a workload associated with a received network packet 103 may need to be routing in a split fashion, for example based on a number of factors, such as current computing capacities of the computing units, or such as any of the data parameters mentioned and described above.

Some embodiments deliver a software stack to help users use hardware-based offloading without hardcoding or learning complex device software development kits (SDKs) when the hardware to offload to is changed. The uniformed methodology of some embodiments advantageously manages and allocates processing resources in order to execute specified workloads, and both autodetects changes to processing resources and auto correlates data parameters to updated processing resources without user intervention. The offloading is “automatic” is that it does not necessarily require a user to hard-code the computing device, such as the library of the computing device, in order for the computing device to be able to use computing units if they have undergone a change.

Some embodiments advantageously decouple the user software stack from the underlying hardware acceleration devices, so that the user does not need to care about calling a specific acceleration device for different workload designs. According to some embodiments, a user may directly call an example software framework without a need for the user to read complex user manuals, to write hardcode, assembly code, or other code in order to change a coding of the an acceleration device after handling the user's relevant requirements.

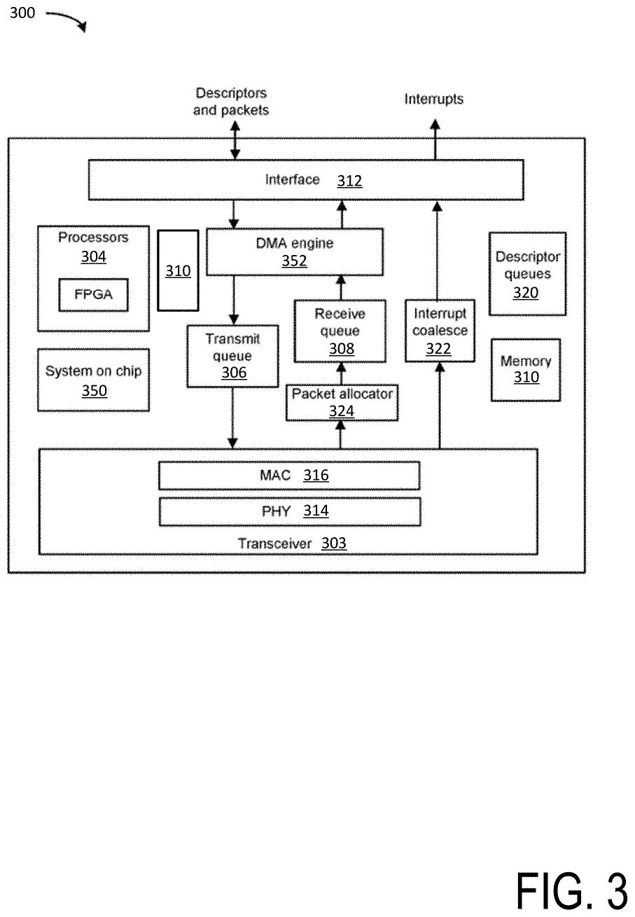

FIG. 3 depicts an example computing device 300 according to some embodiments, such as the computing devices of FIGS. 1 and 2. In some examples, the processing circuitry 310 that is to implement the SAF, similar to processing circuitry 210 of FIG. 2, may include one or more processors, and may continue implementation of embodiments in-line, and even during updates to software executing on the given processors. In some examples, a processing circuitry to implement the SAF can be implemented as a CPU, an XPU, a network interface controller (NIC), network interface card, a host fabric interface (HFI), or host bus adapter (HBA), an infrastructure processing unit (IPU) and such examples can be interchangeable.

Computing device 300 can be coupled to one or more servers using a bus, PCIe, CXL, or DDR. Computing device 300 may be embodied as part of a system-on-a-chip (SoC) that includes one or more processors, included on a multichip package that also contains one or more processors, or embodied as a discrete chip, as an uncore of a component, by way of example.

Some examples of a processing circuitry, similar to that of FIG. 2, may be part an IPU as noted above, or data processing unit (DPU) or utilized by an IPU or DPU. An xPU can refer at least to an IPU, DPU, GPU, GPGPU, or other processing circuitries (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Computing device 300 can include transceiver 303, processors 304, transmit queue 306, receive queue 308, memory 310, and bus interface 312, and DMA engine circuitry 352. The processors 304, system on chip 350, DMA engine 352, transmit queue 306, receive queue 308, interrupt coalesce 322, packet allocator circuitry 324 and descriptor queues 320 may be part of the computing device 300, similar to example to the computing device described in the context of FIGS. 1 and 2 above.

Transceiver 302 can be capable of receiving and transmitting packets in conformance with the applicable protocols such as Ethernet as described in IEEE 802.3, although other protocols may be used. Transceiver 302 can receive and transmit packets from and to a network via a network medium (not depicted). Transceiver 302 can include PHY circuitry 314 and media access control (MAC) circuitry 316. PHY circuitry 314 can include encoding and decoding circuitry (not shown) to encode and decode data packets according to applicable physical layer specifications or standards. MAC circuitry 316 can be configured to assemble data to be transmitted into packets, which include destination and source addresses along with network control information and error detection hash values.

Processors 304 can be any a combination of a: processor, core, graphics processing circuitry (GPU), field programmable gate array (FPGA), application specific integrated circuit (ASIC), or other programmable hardware device that allow programming of network interface of the computing device. For example, a “smart network interface” can provide packet processing capabilities in the network interface using processors 304.

Processors 304 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL), or packet drops due to queue overflow.

Configuration of operation of processors 304, including its data plane, can be programmed using Programming Protocol-independent Packet Processors (P4), C, Python, Broadcom Network Programming Language (NPL), Infrastructure Programmer Development Kit (IPDK), or x86 compatible executable binaries or other executable binaries. Processors 304 and/or system on chip 350 can execute instructions to configure and utilize one or more circuitry as well as check against violation against use configurations, as described herein.

Packet allocator circuitry 324 can provide distribution of received packets for processing by multiple computing units, such as computing units 114 of FIG. 1, and can do so using packet data allocation to various cache physical locations for various ones of the computing units. In one embodiment, the packet allocator circuitry 324 may correspond to processing circuitry 310 (the two may be the same, which is not shown in FIG. 3). When packet allocator circuitry 324 uses RSS, packet allocator circuitry 324 can calculate a hash or make another determination based on contents of a received packet to determine which CPU or core is to process a packet. The latter provides one example of implementation regarding allocation of a packet to a CPU, but also, additionally and in a related manner, to an embodiment where the packet allocator circuitry 324 is adapted to manage data routing operations by selecting one or more of the processors 304 according to an embodiment. Packet allocator circuitry 324 could, in one embodiment, be included within processors 304, or it could be separate from it.

Interrupt coalesce circuitry 322 can perform interrupt moderation whereby network interface interrupt coalesce circuitry 322 waits for multiple packets to arrive, or for a time-out to expire, before generating an interrupt to host system to process received packet(s). Receive Segment Coalescing (RSC) can be performed by network interface of computing device 102 whereby portions of incoming packets are combined into segments of a packet. A network interface may provide this coalesced packet to an application.

Direct memory access (DMA) engine circuitry 352 is configured to copy a packet header, packet payload, and/or descriptor directly from host memory to the network interface or vice versa, instead of copying the packet to an intermediate buffer at the host and then using another copy operation from the intermediate buffer to the destination buffer.

Memory 310 can be any type of volatile or non-volatile memory device and can store any queue or instructions used to program the computing device 302. Transmit queue 306 can include data or references to data for transmission by network interface of computing device 102. Receive queue 308 can include data or references to data that was received by network interface of computing device 200 from a network. Descriptor queues 320 can include descriptors that reference data or packets in transmit queue 306 or receive queue 308. Bus interface 212 can provide an interface with a server For example, bus interface 212 can be compatible with at least one of Peripheral Component Interconnect (PCI), PCI express (PCIe), PCIx, Universal Chiplet Interconnect Express (UCIe), Intel On-chip System Fabric (IOSF), Gen-Z, Open Coherent Accelerator Processor Interface (OpenCAPI), and/or Compute Express Link (CXL), Serial ATA, and/or USB compatible interface (although other interconnection standards may be used).

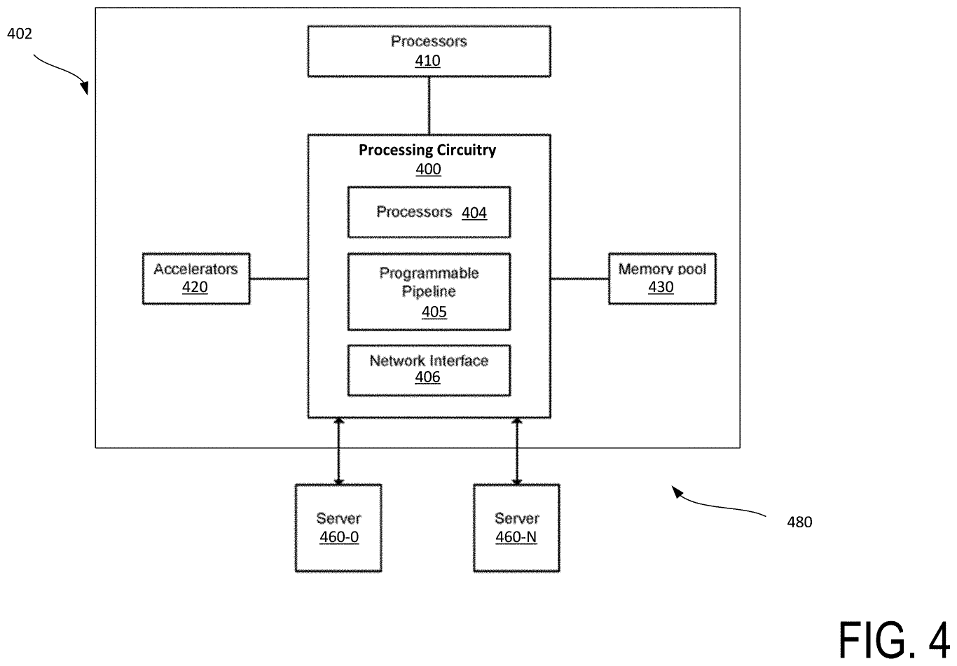

FIG. 4 depicts an example system in the form of computing device 402 that may be used to implement some embodiments. In this system, processing circuitry 400 may correspond to processing circuitries 200 or 300 of FIG. 2 or 3, and manages performance of one or more processes according to some embodiments using one or more of processors 404. Processing circuitry 400 may interface with processors 410, accelerators 420, and memory pool 430 of computing device 102, and with servers 440-0 to 440-N of a computing network 480, where N is an integer of 1 or more. In some examples, processors 404 of processing circuitry 400 can execute one or more processes, applications, VMs, containers, microservices, and so forth that request performance of workloads by one or more of: processors 410, accelerators 420, memory pool 430, and/or servers 440-0 to 440-N. Processing circuitry 400 can utilize network interface 406 or one or more device interfaces to communicate with processors 410, accelerators 420, memory pool 430, and/or servers 440-0 to 440-N. Processing circuitry 400 can utilize programmable pipeline 405 to process packets that are to be transmitted from network interface 202 or packets received from network interface 202.

In some examples, configuration of programmable pipelines 405 can be programmed using a processor of processors 410 and operation of programmable pipelines 405 can continue during updates to software executing on the processor, or other unavailability of the processor, as a second processor of processors 404 provides connectivity to a host such as one or more of servers 460-0 to 460-N and the second processor can configure operation of programmable pipelines 405.

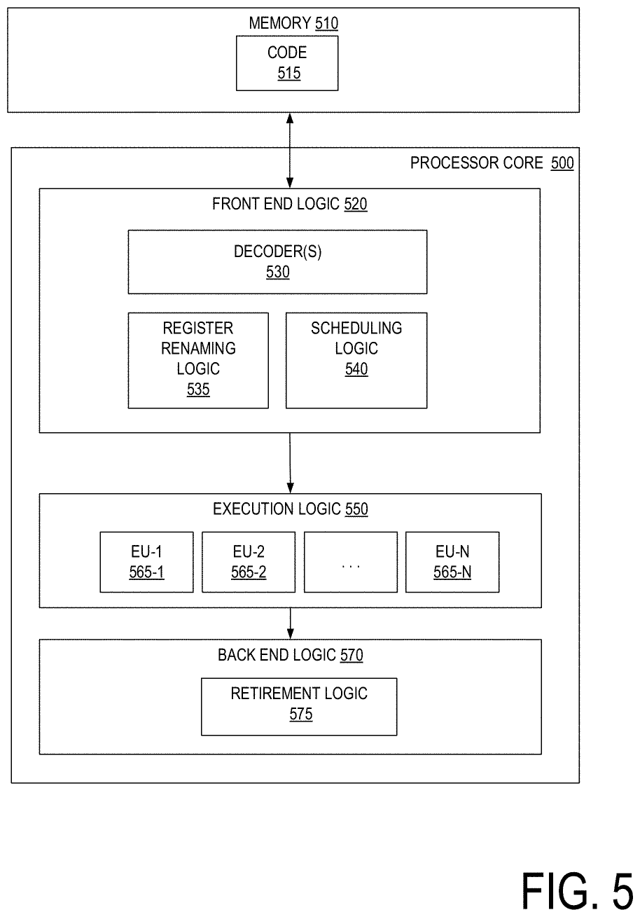

FIG. 5 is a block diagram of an exemplary processor core 500 to execute computer-executable instructions as part of implementing technologies according to embodiments described herein. The processor core 500 can be a core for any type of processor, such as a microprocessor, an embedded processor, a digital signal processor (DSP) or a network processor. The processor core 500 can be a single-threaded core or a multithreaded core in that it may include more than one hardware thread context (or “logical processor”) per core.

FIG. 5 also illustrates a memory 510 coupled to the processor 500. The memory 510 can be any memory described herein or any other memory known to those of skill in the art. The memory 510 can store computer-executable instruction 515 (code) executable by the processor core 500.

The processor core comprises front-end logic 520 that receives instructions from the memory 510. An instruction can be processed by one or more decoders 530. The decoder 530 can generate as its output a micro operation such as a fixed width micro operation in a predefined format, or generate other instructions, microinstructions, or control signals, which reflect the original code instruction. The front-end logic 520 further comprises register renaming logic 535 and scheduling logic 540, which generally allocate resources and queues operations corresponding to converting an instruction for execution.

The processor core 500 further comprises execution logic 550, which comprises one or more execution units (EUs) 565-1 through 565-N. Some processor core embodiments can include a number of execution units dedicated to specific functions or sets of functions. Other embodiments can include only one execution unit or one execution unit that can perform a particular function. The execution logic 550 performs the operations specified by code instructions. After completion of execution of the operations specified by the code instructions, back-end logic 570 retires instructions using retirement logic 575. In some embodiments, the processor core 500 allows out of order execution but requires in-order retirement of instructions. Retirement logic 570 can take a variety of forms as known to those of skill in the art (e.g., re-order buffers or the like).

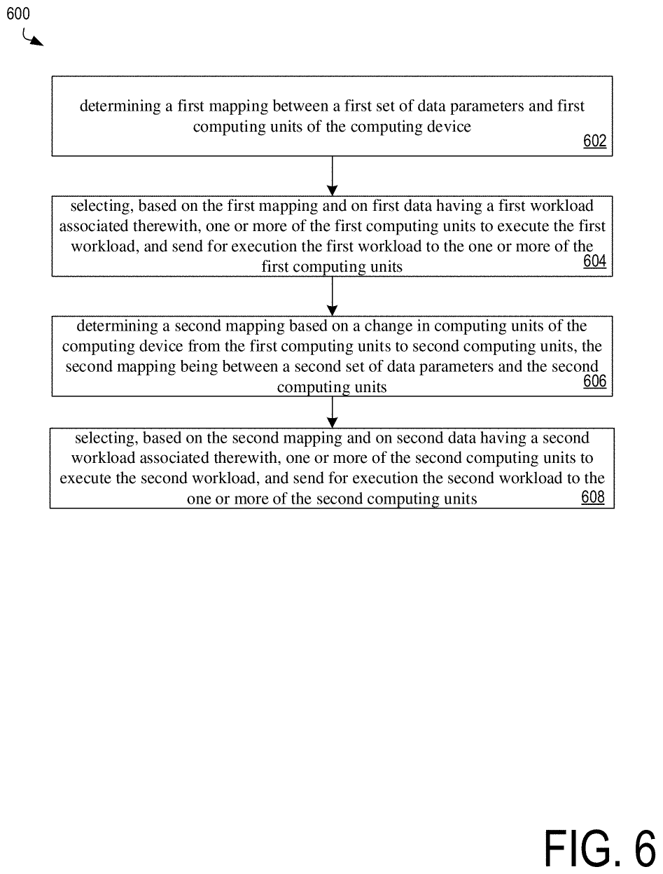

The processor core 500 is transformed during execution of instructions, at least in terms of the output generated by the decoder 530, hardware registers and tables utilized by the register renaming logic 535, and any registers (not shown) modified by the execution logic 550. Although not illustrated in FIG. 6, a processor can include other elements on an integrated chip with the processor core 500. For example, a processor may include additional elements such as memory control logic, one or more graphics engines, I/O control logic and/or one or more caches.

FIG. 6 depicts a process 600 to be performed at a processing circuitry of a computing device in a computing network, the computing device including a plurality of computing units, the computing units including a central processing units (CPU) and one or more accelerator processing units (APUs) according to some embodiments. The process 600 at operation 602 includes determining a first mapping between a first set of data parameters and first computing units of the computing device. The process 600 at operation 604 includes selecting, based on the first mapping and on first data having a first workload associated therewith, one or more of the first computing units to execute the first workload, and send for execution the first workload to the one or more of the first computing units. The process 600 at operation 606 includes determining a second mapping based on a change in computing units of the computing device from the first computing units to second computing units, the second mapping being between a second set of data parameters and the second computing units. The process 600 at operation 608 includes selecting, based on the second mapping and on second data having a second workload associated therewith, one or more of the second computing units to execute the second workload, and send for execution the second workload to the one or more of the second computing units.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing circuitry, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores,” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

### Examples

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes an apparatus of a computing network, the computing network including a plurality of computing units, the computing units including a central processing units (CPU) and one or more accelerator processing units (APUs), the apparatus including an input, an output, and a processing circuitry coupled to the input and to the output, the processing circuitry to: determine a first mapping between a first set of data parameters and first computing units of the computing network; select, based on the first mapping and on first data having a first workload associated therewith, one or more of the first computing units to execute the first workload, and send for execution the first workload to the one or more of the first computing units; determine a second mapping based on a change in computing units of the computing network from the first computing units to second computing units, the second mapping being between a second set of data parameters and the second computing units; and select, based on the second mapping and on second data having a second workload associated therewith, one or more of the second computing units to execute the second workload, and send for execution the second workload to the one or more of the second computing units.

Example 2 includes the subject matter of Example 1, wherein the computing units are in a single computing device, the computing device including the processing circuitry.

Example 3 includes the subject matter of Example 2, wherein the processing circuitry is part of the CPU.

Example 4 includes the subject matter of Example 1, wherein a parameter of at least one of the first set of data parameters or the second set of data parameters includes data size.

Example 5 includes the subject matter of Example 4, wherein a parameter of at least one of the first set of data parameters or the second set of data parameters further includes at least one of: a data source location, expected workload power usage, or whether data batch processing is possible at corresponding ones of said one or more of the first computing units or said one or more of the second computing units.

Example 6 includes the subject matter of Example 4, wherein a parameter of at least one of the first set of data parameters or the second set of data parameters includes workload type.

Example 7 includes the subject matter of Example 4, wherein workload type includes information on a workload action including at least one of: encryption, decryption, compression, decompression, machine learning, streaming data movement, streaming data transformation, or data input/output (I/O).

Example 8 includes the subject matter of Example 4, wherein workload type includes information on whether workload execution is to be in a confidential compute environment.

Example 9 includes the subject matter of Example 8, wherein, in response to a determination that the workload execution is to be in a confidential compute environment, at least one of the first mapping or the second mapping are to map, respectively, the first data and the second data to the CPU.

Example 10 includes the subject matter of Example 1, the processing circuitry to access the first data and the second data by accessing, respectively, a first application programming interface (API) call and a second API call from a library of the computing device, wherein, if a difference exists between the first API call and the second API call, the difference is not based on the change in the computing units.

Example 11 includes the subject matter of Example 2, wherein the processing circuitry is to determine the first mapping or the second mapping by accessing the first mapping or the second mapping, respectively, from a memory of the computing network, the memory within the computing device or external to the computing device.

Example 12 includes the subject matter of Example 11, wherein, when the memory is external to the computing device, the processing circuitry is to generate entries of the second mapping and to send the entries for storage in the memory as part of the second mapping, the second mapping including a cluster map of mappings of multiple computing devices of the computing network.

Example 13 includes the subject matter of Example 1, wherein the processing circuitry is to determine the second mapping by: detecting the change in computing units from the first computing units to the second computing units; and implementing an initialization function of the apparatus, the initialization function including one of more learning cycles, individual ones of the learning cycles including: sending, for execution by at least some of the second computing units, an incoming workload associated with incoming data; and determining performance data on execution of the incoming workload by individual ones of said at least some of the second computing units; and generating entries of the second mapping based on the performance data; and sending the second mapping for storage in a memory.

Example 14 includes the subject matter of Example 13, wherein detecting the change in computing units includes, for individual ones of the second computing units, determining information on computing unit type, the information on computing unit type including at least one of information on whether said individual ones of the second computing units include a CPU or an APU, or information on APU type.

Example 15 includes the subject matter of Example 13, wherein performing the initialization function includes using a machine learning algorithm.

Example 16 includes the subject matter of Example 13, wherein the processing circuitry is to implement the initialization function inline while sending for execution the first workload to the one or more of the first computing units.

Example 17 includes the subject matter of Example 13, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

Example 18 includes the subject matter of Example 17, wherein the entries map the second set of data parameters to corresponding ones of the second computing units that exhibit a highest speed of execution of the incoming workload among the second computing units.

Example 19 includes the subject matter of Example 17, wherein determining performance metrics includes requesting performance data from the second computing units.

Example 20 includes the subject matter of Example 1, wherein at least one of selecting one or more of the first computing units or selecting one or more of the second computing units is based on a current load of corresponding ones of the one or more of the first computing units or the one or more of the second computing units.

Example 21 includes a non-transitory computer-readable storage medium comprising instructions stored thereon, that when executed by a processing circuitry of a computing device in a computing network, the computing device including a plurality of computing units, the computing units including a central processing units (CPU) and one or more accelerator processing units (APUs), cause the processing circuitry to perform operations including: determining a first mapping between a first set of data parameters and first computing units of the computing device; selecting, based on the first mapping and on first data having a first workload associated therewith, one or more of the first computing units to execute the first workload, and send for execution the first workload to the one or more of the first computing units; determining a second mapping based on a change in computing units of the computing device from the first computing units to second computing units, the second mapping being between a second set of data parameters and the second computing units; and selecting, based on the second mapping and on second data having a second workload associated therewith, one or more of the second computing units to execute the second workload, and send for execution the second workload to the one or more of the second computing units.

Example 22 includes the subject matter of Example 21, wherein the processing circuitry is part of a CPU of the computing device.

Example 23 includes the subject matter of Example 21, wherein a parameter of at least one of the first set of data parameters or the second set of data parameters includes data size.

Example 24 includes the subject matter of Example 23, wherein a parameter of at least one of the first set of data parameters or the second set of data parameters further includes at least one of: a data source location, expected workload power usage, or whether data batch processing is possible at corresponding ones of said one or more of the first computing units or said one or more of the second computing units.

Example 25 includes the subject matter of Example 23, wherein a parameter of at least one of the first set of data parameters or the second set of data parameters includes workload type.

Example 26 includes the subject matter of Example 23, wherein workload type includes information on a workload action including at least one of: encryption, decryption, compression, decompression, machine learning, streaming data movement, streaming data transformation, or data input/output (I/O).

Example 27 includes the subject matter of Example 23, wherein workload type includes information on whether workload execution is to be in a confidential compute environment.

Example 28 includes the subject matter of Example 27, wherein, in response to a determination that the workload execution is to be in a confidential compute environment, at least one of the first mapping or the second mapping are to map, respectively, the first data and the second data to the CPU.

Example 29 includes the subject matter of Example 21, wherein the operations further include accessing the first data and the second data by accessing, respectively, a first application programming interface (API) call and a second API call from a library of the computing device, wherein, if a difference exists between the first API call and the second API call, the difference is not based on the change in the computing units.

Example 30 includes the subject matter of Example 21, wherein the operations further include determining the first mapping or the second mapping by accessing the first mapping or the second mapping, respectively, from a memory, the memory within the computing device or external to the computing device.

Example 31 includes the subject matter of Example 30, wherein, when the memory is external to the computing device, wherein the operations further include generating entries of the second mapping and to send the entries for storage in the memory as part of the second mapping, the second mapping including a cluster map of mappings of multiple computing devices of the computing network.

Example 32 includes the subject matter of Example 21, wherein the operations further include determining the second mapping by: detecting the change in computing units from the first computing units to the second computing units; and implementing an initialization function of the apparatus, the initialization function including one of more learning cycles, individual ones of the learning cycles including: sending, for execution by at least some of the second computing units, an incoming workload associated with incoming data; and determining performance data on execution of the incoming workload by individual ones of said at least some of the second computing units; and generating entries of the second mapping based on the performance data; and sending the second mapping for storage in a memory.

Example 33 includes the subject matter of Example 32, wherein detecting the change in computing units includes, for individual ones of the second computing units, determining information on computing unit type, the information on computing unit type including at least one of information on whether said individual ones of the second computing units include a CPU or an APU, or information on APU type.

Example 34 includes the subject matter of Example 32, wherein performing the initialization function includes using a machine learning algorithm.

Example 35 includes the subject matter of Example 32, wherein the operations further include implementing the initialization function inline while sending for execution the first workload to the one or more of the first computing units.

Example 36 includes the subject matter of Example 32, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

Example 37 includes the subject matter of Example 36, wherein the entries map the second set of data parameters to corresponding ones of the second computing units that exhibit a highest speed of execution of the incoming workload among the second computing units.

Example 38 includes the subject matter of Example 36, wherein determining performance metrics includes requesting performance data from the second computing units.

Example 39 includes the subject matter of Example 21, wherein at least one of selecting one or more of the first computing units or selecting one or more of the second computing units is based on a current load of corresponding ones of the one or more of the first computing units or the one or more of the second computing units.

Example 40 includes a method to be performed at a processing circuitry of a computing device in a computing network, the computing device including a plurality of computing units, the computing units including a central processing units (CPU) and one or more accelerator processing units (APUs), the method including: determining a first mapping between a first set of data parameters and first computing units of the computing device; selecting, based on the first mapping and on first data having a first workload associated therewith, one or more of the first computing units to execute the first workload, and send for execution the first workload to the one or more of the first computing units; determining a second mapping based on a change in computing units of the computing device from the first computing units to second computing units, the second mapping being between a second set of data parameters and the second computing units; and selecting, based on the second mapping and on second data having a second workload associated therewith, one or more of the second computing units to execute the second workload, and send for execution the second workload to the one or more of the second computing units.

Example 41 includes the subject matter of Example 40, wherein the processing circuitry is part of a CPU of the computing device.

Example 42 includes the subject matter of Example 40, wherein a parameter of at least one of the first set of data parameters or the second set of data parameters includes data size.

Example 43 includes the subject matter of Example 42, wherein a parameter of at least one of the first set of data parameters or the second set of data parameters further includes at least one of: a data source location, expected workload power usage, or whether data batch processing is possible at corresponding ones of said one or more of the first computing units or said one or more of the second computing units.

Example 44 includes the subject matter of Example 42, wherein a parameter of at least one of the first set of data parameters or the second set of data parameters includes workload type.

Example 45 includes the subject matter of Example 42, wherein workload type includes information on a workload action including at least one of: encryption, decryption, compression, decompression, machine learning, streaming data movement, streaming data transformation, or data input/output (I/O).

Example 46 includes the subject matter of Example 42, wherein workload type includes information on whether workload execution is to be in a confidential compute environment.

Example 47 includes the subject matter of Example 46, wherein, in response to a determination that the workload execution is to be in a confidential compute environment, at least one of the first mapping or the second mapping are to map, respectively, the first data and the second data to the CPU.

Example 48 includes the subject matter of Example 40, further including accessing the first data and the second data by accessing, respectively, a first application programming interface (API) call and a second API call from a library of the computing device, wherein, if a difference exists between the first API call and the second API call, the difference is not based on the change in the computing units.

Example 49 includes the subject matter of Example 40, further including determining the first mapping or the second mapping by accessing the first mapping or the second mapping, respectively, from a memory, the memory within the computing device or external to the computing device.

Example 50 includes the subject matter of Example 49, further including, when the memory is external to the computing device, generating entries of the second mapping and to send the entries for storage in the memory as part of the second mapping, the second mapping including a cluster map of mappings of multiple computing devices of the computing network.

Example 51 includes the subject matter of Example 40, further including determining the second mapping by: detecting the change in computing units from the first computing units to the second computing units; and implementing an initialization function of the apparatus, the initialization function including one of more learning cycles, individual ones of the learning cycles including: sending, for execution by at least some of the second computing units, an incoming workload associated with incoming data; and determining performance data on execution of the incoming workload by individual ones of said at least some of the second computing units; and generating entries of the second mapping based on the performance data; and sending the second mapping for storage in a memory.

Example 52 includes the subject matter of Example 51, wherein detecting the change in computing units includes, for individual ones of the second computing units, determining information on computing unit type, the information on computing unit type including at least one of information on whether said individual ones of the second computing units include a CPU or an APU, or information on APU type.

Example 53 includes the subject matter of Example 51, wherein performing the initialization function includes using a machine learning algorithm.

Example 54 includes the subject matter of Example 51, further including implementing the initialization function inline while sending for execution the first workload to the one or more of the first computing units.

Example 55 includes the subject matter of Example 51, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

Example 56 includes the subject matter of Example 55, wherein the entries map the second set of data parameters to corresponding ones of the second computing units that exhibit a highest speed of execution of the incoming workload among the second computing units.

Example 57 includes the subject matter of Example 55, wherein determining performance metrics includes requesting performance data from the second computing units.

Example 58 includes the subject matter of Example 40, wherein at least one of selecting one or more of the first computing units or selecting one or more of the second computing units is based on a current load of corresponding ones of the one or more of the first computing units or the one or more of the second computing units.

Example 59 includes a system of a computing network, the system including: a plurality of computing units, the computing units including a central processing units (CPU) and one or more accelerator processing units (APUs); and a processing circuitry coupled to the CPU and to the one or more APUs, the processor circuitry to: determine a first mapping between a first set of data parameters and first computing units of the computing network; select, based on the first mapping and on first data having a first workload associated therewith, one or more of the first computing units to execute the first workload, and send for execution the first workload to the one or more of the first computing units; determine a second mapping based on a change in computing units of the computing network from the first computing units to second computing units, the second mapping being between a second set of data parameters and the second computing units; and select, based on the second mapping and on second data having a second workload associated therewith, one or more of the second computing units to execute the second workload, and send for execution the second workload to the one or more of the second computing units.

Example 60 includes the subject matter of Example 59, wherein the computing units are in a single computing device, the computing device including the processing circuitry.

Example 61 includes the subject matter of Example 60, wherein the processing circuitry is part of the CPU.

Example 62 includes the subject matter of Example 59, wherein a parameter of at least one of the first set of data parameters or the second set of data parameters includes data size.

Example 63 includes the subject matter of Example 62, wherein a parameter of at least one of the first set of data parameters or the second set of data parameters further includes at least one of: a data source location, expected workload power usage, or whether data batch processing is possible at corresponding ones of said one or more of the first computing units or said one or more of the second computing units.

Example 64 includes the subject matter of Example 62, wherein a parameter of at least one of the first set of data parameters or the second set of data parameters includes workload type.

Example 65 includes the subject matter of Example 62, wherein workload type includes information on a workload action including at least one of: encryption, decryption, compression, decompression, machine learning, streaming data movement, streaming data transformation, or data input/output (I/O).

Example 66 includes the subject matter of Example 62, wherein workload type includes information on whether workload execution is to be in a confidential compute environment.

Example 67 includes the subject matter of Example 66, wherein, in response to a determination that the workload execution is to be in a confidential compute environment, at least one of the first mapping or the second mapping are to map, respectively, the first data and the second data to the CPU.

Example 68 includes the subject matter of Example 59, the processing circuitry to access the first data and the second data by accessing, respectively, a first application programming interface (API) call and a second API call from a library of the computing device, wherein, if a difference exists between the first API call and the second API call, the difference is not based on the change in the computing units.

Example 69 includes the subject matter of Example 60, wherein the processing circuitry is to determine the first mapping or the second mapping by accessing the first mapping or the second mapping, respectively, from a memory of the computing network, the memory within the computing device or external to the computing device.

Example 70 includes the subject matter of Example 69, wherein, when the memory is external to the computing device, the processing circuitry is to generate entries of the second mapping and to send the entries for storage in the memory as part of the second mapping, the second mapping including a cluster map of mappings of multiple computing devices of the computing network.

Example 71 includes the subject matter of Example 59, wherein the processing circuitry is to determine the second mapping by: detecting the change in computing units from the first computing units to the second computing units; and implementing an initialization function of the apparatus, the initialization function including one of more learning cycles, individual ones of the learning cycles including: sending, for execution by at least some of the second computing units, an incoming workload associated with incoming data; and determining performance data on execution of the incoming workload by individual ones of said at least some of the second computing units; and generating entries of the second mapping based on the performance data; and sending the second mapping for storage in a memory.

Example 72 includes the subject matter of Example 71, wherein detecting the change in computing units includes, for individual ones of the second computing units, determining information on computing unit type, the information on computing unit type including at least one of information on whether said individual ones of the second computing units include a CPU or an APU, or information on APU type.

Example 73 includes the subject matter of Example 71, wherein performing the initialization function includes using a machine learning algorithm.

Example 74 includes the subject matter of Example 71, wherein the processing circuitry is to implement the initialization function inline while sending for execution the first workload to the one or more of the first computing units.

Example 75 includes the subject matter of Example 71, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

Example 76 includes the subject matter of Example 75, wherein the entries map the second set of data parameters to corresponding ones of the second computing units that exhibit a highest speed of execution of the incoming workload among the second computing units.

Example 77 includes the subject matter of Example 75, wherein determining performance metrics includes requesting performance data from the second computing units.

Example 78 includes the subject matter of Example 59, wherein at least one of selecting one or more of the first computing units or selecting one or more of the second computing units is based on a current load of corresponding ones of the one or more of the first computing units or the one or more of the second computing units.

Example 79 includes an apparatus including means for performing a method according to any one of claims 40-58.

Example 80 includes a computer readable storage medium including code which, when executed, is to cause a machine to perform any of the methods of claims 40-58.

Example 81 includes a method to perform the functionalities of any one of Examples 40-58.

Example 82 includes a non-transitory computer-readable storage medium comprising instructions stored thereon, that when executed by one or more processors of a packet processing device, cause the one or more processors to perform the functionalities of any one of Examples 40-58.

Example 83 includes means to perform the functionalities of any one of Examples 40-58.

1. An apparatus of a computing network, the computing network including a plurality of computing units, the computing units including a central processing units (CPU) and one or more accelerator processing units (APUs), the apparatus including an input, an output, and a processing circuitry coupled to the input and to the output, the processing circuitry to:
determine a first mapping between a first set of data parameters and first computing units of the computing network;
select, based on the first mapping and on first data having a first workload associated therewith, one or more of the first computing units to execute the first workload, and send for execution the first workload to the one or more of the first computing units;
determine a second mapping based on a change in computing units of the computing network from the first computing units to second computing units, the second mapping being between a second set of data parameters and the second computing units; and
select, based on the second mapping and on second data having a second workload associated therewith, one or more of the second computing units to execute the second workload, and send for execution the second workload to the one or more of the second computing units.

2. The apparatus of claim 1, wherein the computing units are in a single computing device, the computing device including the processing circuitry.

3. The apparatus of claim 2, wherein the processing circuitry is part of the CPU.

4. The apparatus of claim 1, wherein a parameter of at least one of the first set of data parameters or the second set of data parameters includes data size.

5. The apparatus of claim 4, wherein a parameter of at least one of the first set of data parameters or the second set of data parameters further includes at least one of: a data source location, expected workload power usage, or whether data batch processing is possible at corresponding ones of said one or more of the first computing units or said one or more of the second computing units.

6. The apparatus of claim 4, wherein a parameter of at least one of the first set of data parameters or the second set of data parameters includes workload type.

7. The apparatus of claim 4, wherein workload type includes information on a workload action including at least one of: encryption, decryption, compression, decompression, machine learning, streaming data movement, streaming data transformation, or data input/output (I/O).

8. The apparatus of claim 4, wherein workload type includes information on whether workload execution is to be in a confidential compute environment.

9. The apparatus of claim 8, wherein, in response to a determination that the workload execution is to be in a confidential compute environment, at least one of the first mapping or the second mapping are to map, respectively, the first data and the second data to the CPU.

10. The apparatus of claim 1, the processing circuitry to access the first data and the second data by accessing, respectively, a first application programming interface (API) call and a second API call from a library of the computing device, wherein, if a difference exists between the first API call and the second API call, the difference is not based on the change in the computing units.

11. A non-transitory computer-readable storage medium comprising instructions stored thereon, that when executed by a processing circuitry of a computing device in a computing network, the computing device including a plurality of computing units, the computing units including a central processing units (CPU) and one or more accelerator processing units (APUs), cause the processing circuitry to perform operations including:
determining a first mapping between a first set of data parameters and first computing units of the computing device;
selecting, based on the first mapping and on first data having a first workload associated therewith, one or more of the first computing units to execute the first workload, and send for execution the first workload to the one or more of the first computing units;
determining a second mapping based on a change in computing units of the computing device from the first computing units to second computing units, the second mapping being between a second set of data parameters and the second computing units; and
selecting, based on the second mapping and on second data having a second workload associated therewith, one or more of the second computing units to execute the second workload, and send for execution the second workload to the one or more of the second computing units.

12. The storage medium of claim 11, wherein the processing circuitry is part of a CPU of the computing device.

13. The storage medium of claim 11, wherein the operations further include determining the first mapping or the second mapping by accessing the first mapping or the second mapping, respectively, from a memory, the memory within the computing device or external to the computing device.

14. The storage medium of claim 13, wherein, when the memory is external to the computing device, wherein the operations further include generating entries of the second mapping and to send the entries for storage in the memory as part of the second mapping, the second mapping including a cluster map of mappings of multiple computing devices of the computing network.

15. The storage medium of claim 11, wherein the operations further include determining the second mapping by:
detecting the change in computing units from the first computing units to the second computing units; and
implementing an initialization function of the apparatus, the initialization function including one of more learning cycles, individual ones of the learning cycles including:
sending, for execution by at least some of the second computing units, an incoming workload associated with incoming data; and
determining performance data on execution of the incoming workload by individual ones of said as least some of the second computing units; and
generating entries of the second mapping based on the performance data; and
sending the second mapping for storage in a memory.

16. A method to be performed at a processing circuitry of a computing device in a computing network, the computing device including a plurality of computing units, the computing units including a central processing units (CPU) and one or more accelerator processing units (APUs), the method including:
determining a first mapping between a first set of data parameters and first computing units of the computing device;
selecting, based on the first mapping and on first data having a first workload associated therewith, one or more of the first computing units to execute the first workload, and send for execution the first workload to the one or more of the first computing units;
determining a second mapping based on a change in computing units of the computing device from the first computing units to second computing units, the second mapping being between a second set of data parameters and the second computing units; and
selecting, based on the second mapping and on second data having a second workload associated therewith, one or more of the second computing units to execute the second workload, and send for execution the second workload to the one or more of the second computing units.

17. The method of claim 16, further including determining the second mapping by:
detecting the change in computing units from the first computing units to the second computing units; and
implementing an initialization function of the apparatus, the initialization function including one of more learning cycles, individual ones of the learning cycles including:
sending, for execution by at least some of the second computing units, an incoming workload associated with incoming data; and
determining performance data on execution of the incoming workload by individual ones of said as least some of the second computing units; and
generating entries of the second mapping based on the performance data; and
sending the second mapping for storage in a memory.

18. The method of claim 17, wherein detecting the change in computing units includes, for individual ones of the second computing units, determining information on computing unit type, the information on computing unit type including at least one of information on whether said individual ones of the second computing units include a CPU or an APU, or information on APU type.

19. The method of claim 18, wherein performing the initialization function includes using a machine learning algorithm.

20. The method of claim 18, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

21. A system of a computing network, the system including:
a plurality of computing units, the computing units including a central processing units (CPU) and one or more accelerator processing units (APUs); and
a processing circuitry coupled to the CPU and to the one or more APUs, the processor circuitry to:
determine a first mapping between a first set of data parameters and first computing units of the computing network;
select, based on the first mapping and on first data having a first workload associated therewith, one or more of the first computing units to execute the first workload, and send for execution the first workload to the one or more of the first computing units;
determine a second mapping based on a change in computing units of the computing network from the first computing units to second computing units, the second mapping being between a second set of data parameters and the second computing units; and
select, based on the second mapping and on second data having a second workload associated therewith, one or more of the second computing units to execute the second workload, and send for execution the second workload to the one or more of the second computing units.

22. The system of claim 21, wherein the processing circuitry is to determine the second mapping by:
detecting the change in computing units from the first computing units to the second computing units; and
implementing an initialization function of the apparatus, the initialization function including one of more learning cycles, individual ones of the learning cycles including:
sending, for execution by at least some of the second computing units, an incoming workload associated with incoming data; and
determining performance data on execution of the incoming workload by individual ones of said as least some of the second computing units; and
generating entries of the second mapping based on the performance data; and
sending the second mapping for storage in a memory.

23. The system of claim 22, wherein the performance data includes performance metrics, the performance metrics including at least one of speeds of execution of the incoming workload by corresponding ones of the second computing units, power consumption associated with execution of the incoming workload by corresponding ones of the second computing units, number or type of errors associated with execution of the incoming workload by the corresponding ones of the second computer units, or current power consumption associated with individual ones of the second computing units prior to sending the incoming workload for execution by the second computing units.

24. The system of claim 23, wherein the entries map the second set of data parameters to corresponding ones of the second computing units that exhibit a highest speed of execution of the incoming workload among the second computing units.

25. The system of claim 23, wherein determining performance metrics includes requesting performance data from the second computing units.
